(19) United States
(12) Patent Application Publication
(10) Pub. No.: US 2026/0339432 A1
(43) Pub. Date: Oct. 29, 2026

(54) FITMENT ISSUE DETECTION BASED ON USER ADJUSTMENTS AND SENSOR MEASUREMENTS

(71) Applicant: Apple Inc., Cupertino, CA (US)

(72) Inventors: Carolyn Boccignone, Sunnyvale, CA (US); Yuri Pekelny, Seattle, WA (US); Daniel Kurz, San Francisco, CA (US)

(73) Assignee: Apple Inc., Cupertino, CA (US)

(21) Appl. No.: 19/637,348

(22) Filed: Apr. 2, 2026

Related U.S. Application Data
(60) Provisional application No. 63/794,977, filed on Apr. 25, 2025.

(51) Int. Cl. G06F 3/01; G06T 7/70

(52) U.S. Cl. CPC G06F 3/013; G06T 7/70; G06T 2207/30201

(57) ABSTRACT

Techniques are disclosed that detect fitment issues of a headset based on sensor data. In some examples, data is obtained from one or more sensors (e.g., image sensors, motion sensors, light sensors, and/or proximity sensors) that is used to determine whether there is a fitment issue with the headset. When a possible fitment issue is detected, a notification can be provided to the user that is directed at assisting the user in correcting the fitment issue.

### CROSS-REFERENCES TO OTHER APPLICATIONS

This application claims priority to U.S. Provisional Application No. 63/794,977, for “FITMENT ISSUE DETECTION BASED ON USER ADJUSTMENTS AND SENSOR MEASUREMENTS” filed on Apr. 25, 2025, which is herein incorporated by reference in its entirety for all purposes.

### BACKGROUND

Headsets for virtual reality (VR), extended reality (XR), augmented reality (AR), and mixed reality (MR) are evolving rapidly, and can offer potential benefits, diverse applications, and abundant opportunities for the future. These different headsets have different weights, sizes, and components (e.g., light seals, bands, . . . ). Configuring these headsets for a proper fit on a user, however, can be challenging.

### SUMMARY

Various techniques are provided for detecting fitment issues of a headset device based on user adjustments and sensor measurements. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes performing a method. In some examples, the method includes detecting, via one or more sensors of the headset device, an indication that a user has placed the headset device on a head of the user; performing, using at least one of the one or more sensors of the headset device, one or more measurements for contact between the head of the user and the headset device; determining one or more contact measures between the head of the user and the headset device using the one or more measurements; comparing the one or more contact measures to one or more predetermined device fit parameters; determining the one or more contact measures do not satisfy the one or more predetermined device fit parameters; and responsive to the determination, providing, to the user, a notification indicating a quality of fit for the user.

In some examples, the one or more sensors may include one or more sound sensors that recognizes the user is present. In some examples, the one or more sensors may include at least one of one or more pressure sensors, one or more sound sensors, or one or more light sensors. In some examples, the method further may include capturing, using one or more cameras of the headset device, images associated with the headset device. In some examples, the one or more measurements comprise determining, via the images, positions of eyes of the user and distance between eyes of the user and lenses of the headset device. In some examples, determining the one or more contact measures between the head of the user and the headset device using the one or more measurements comprises determining a pressure measurement at different locations of the headset device. In some examples, the method also includes detecting, via the one or more sensors of the headset device, a user adjustment event that indicates the user has made an adjustment to the headset device. In some examples, detecting the user adjustment event comprises using one or more machine learning models. In some examples, providing, to the user, the notification indicating a quality of fit for the user is based, at least in part, on the user adjustment event. In some examples, determining the one or more contact measures do not satisfy the one or more predetermined device fit parameters comprises using one or more machine learning models. Other embodiments of this aspect include corresponding computer systems, apparatus, and computer programs recorded on one or more computer storage devices, each configured to perform the actions of the methods.

One general aspect includes a method detecting, via one or more sensors of a headset device, an indication that a user has placed the headset device on a head of the user; performing, by at least one of the one or more sensors, a series of measurements; detecting an adjustment event made by the user to the headset device based on the series of measurements; determining that a number of adjustment events exceeds a threshold; an providing, to the user, a notification indicating a quality of fit for the user. In some examples, the method also includes performing additional measurements using the one or more sensors, detecting additional adjustment events using the additional measurements, incrementing an adjustment counter based on detecting the additional adjustment events, and comparing the adjustment counter to a threshold. In some examples, the method also includes the additional measurements comprise sound of the user touching the headset device. In some examples, the additional measurements may include light information that indicates an amount of light entering the headset device. In some examples, the one or more sensors may include one or more of: image sensors, motion sensors, touch sensors, and microphones. In some examples, the series of measurements may include motion information or touch information for the headset device. In some examples, the method may include capturing, using one or more cameras, images of the headset device detecting a hand of the user touching the headset device. In some examples, detecting the user adjustment event comprises using one or more machine learning models. In some examples, the method may include detecting a fitment issue using one or more machine learning models. Other embodiments of this aspect include corresponding computer systems, apparatus, and computer programs recorded on one or more computer storage devices, each configured to perform the actions of the methods.

Other examples are directed to systems, portable consumer devices, and computer readable media associated with techniques described herein. A better understanding of the nature and advantages of examples of the present disclosure may be gained with reference to the following detailed description and the accompanying drawings.

### BRIEF DESCRIPTION OF THE DRAWINGS

FIG. 1A is a diagram illustrating an example headset operating in a physical environment, in accordance with some examples.

FIG. 1B is a diagram illustrating a view, provided via an electronic headset device, of virtual elements within the 3D physical environment of FIG. 1A, and display of a recommendation associated with detection of a possible fitment issue, in accordance with some examples.

FIG. 2A is a diagram illustrating a user wearing an electronic headset device, in accordance with some examples.

FIG. 2B is a diagram illustrating an electronic headset device, in accordance with some examples.

FIG. 3 is a flow diagram illustrating an example architecture of detecting fitment issues, in accordance with some examples.

FIG. 4 illustrates an example architecture for training one or more machine learning models to detect user adjustment events and possible fitment issues based on user adjustments and sensor data, in accordance with some examples.

FIG. 5 illustrates an example machine learning model of a neural network, in accordance with some examples.

FIG. 6 is a flowchart illustrating a method for detecting fitment issues of a headset based on user adjustments detected using one or more sensors, in accordance with some examples.

FIG. 7 is a flowchart illustrating a method for detecting fitment issues based on contact measures, in accordance with some examples.

FIG. 8 is a flowchart illustrating a method for detecting fitment issues of a headset based on repeated user adjustments, in accordance with some examples.

FIG. 9 is a block diagram of an example electronic device, in accordance with some examples.

### DETAILED DESCRIPTION

Headsets can provide an immersive experience for many different types of applications, such as virtual reality (VR) applications, extended reality (XR) applications, augmented reality (AR) applications, mixed reality (MR) applications, and the like. A proper fitting headset is useful for improving a user experience and for improving performance of immersive technologies. The techniques disclosed herein detect possible fitment issues based on user adjustments of the headset and sensor data obtained from one or more sensors of the headset. The sensors used can include, but are not limited to, inertial measurement units (IMUs), cameras, pressure sensors, light sensors, touch sensors, sound sensors, and the like.

As used herein, “fitment” may refer to how well a headset fits a user, and “fitment issue” may refer to a headset that does not fit a user as specified. For example, a fitment issue may indicate that the headset is improperly positioned on the head of a user (e.g., eyes are improperly positioned relative to the display), too much light is entering the headset (e.g., a strap of the headset not tightened properly, light seal not the correct size), the headset is uncomfortable (e.g., user keeps taking on/off the headset, adjusting straps, changing position of the headset, . . . ), the headset keeps sliding down the nose of the user (e.g., nosepiece is not the correct size), and the like. In some examples, a notification (e.g., a recommendation) can be provided to the user when a fitment issue is detected that is based on one or more adjustments to the headset made by the user. The notification may indicate a quality of fit of the headset for the user.

As briefly discussed above, many different types of sensors may be used in detecting a fitment issue of a headset. For instance, a headset may include one or more cameras that detect a position of the user's head within the headset. As an example, one or more eye tracking cameras can be used to determine whether the distance between the user's eyes and display of the headset is the specified distance. A camera can also be used to determine whether the user is wearing the headset too high or too low (e.g., by measuring a vertical eye offset), determine whether the headset is moving down the user's face over a period of time, and the like. Cameras can also be used to detect whether the user's hands are touching the headset for adjustment purposes and be used to determine the frequency of such adjustments.

In some configurations, a headset may include one or more motion sensors (e.g., IMUs, gyroscopic sensors, and the like) that detect movement of the headset. For example, the movement sensors can be used to detect when the user places the headset on their head, when the user removes the headset, when the headset moves, and the like. The movement sensors can also be used to detect distinct adjustment patterns (e.g., a user pushes-up on the headset, acceleration of the headset in a particular direction), a user's head orientation or attitude (e.g., tilted up/down), and the like.

According to some configurations, the headset may include one or more contact sensors, touch sensors and/or pressure sensors. In some examples, these sensors may be used to determine a user adjustment that is associated with a quality of fit of the headset. As an example, sensor data from contact/pressure sensors located on one or more straps of a headset (e.g., solo loop band or dual loop band), can be analyzed to detect that the user has touched the headset and/or the contact and/or pressure with a user's head. In some configurations, the sensors can be located on the headset such that contact/pressure data can be obtained for different portions of the user's head (e.g., front, back, left and right sides of the head, top, bottom, sides of the face, . . . ). According to some examples, the sensors can be positioned on headset such that the contact/pressure data can be used to determine when/where the user has touched the headset device.

In some configurations, a fitment issue can be determined based on a series of measures that can be used to determine one or more contact measures between the head of the user and the headset device. As used herein, the term “contact measure” may refer to a measurement determined from one or more sensors that indicates an amount/level of contact between one or more surfaces of the headset and the head of the user. According to some examples, contact measures can be determined from a detected contact/pressure obtained from different sensors of the headset. As a particular example, a determination can be made as to whether all/portion of the contact/pressure sensors (e.g., 6 out of 10 sensors, 4 out of 5 sensors, . . . ) have a specified amount of contact/pressure against the head. As another example, the sensors data may indicate that only one side, and/or top, of the head is in contact with the headset. Sensors can also be used to determine when a user is touching the headset (e.g., cameras, touch sensors, . . . ) and if the touching is associated with making an adjustment to the fit of the headset.

According to some configurations, the headset may include one or more light sensors. Light sensors can be used to determine how much light is entering the headset and when there is too much light is entering the headset (e.g., above a threshold). Detecting that too much light is entering the headset may indicate that the light seal should be replaced with a different size of light seal and/or that one or more straps is not tightened enough to reduce the amount of light entering the headset. In some configurations, the headset can detect that a user has made an adjustment (e.g., loosened a strap) that results in too much light entering the headset.

In some examples, the headset may include one or more sound sensors (e.g., one or more microphones). The sound sensors can be used to determine when a user is making a user adjustment to the headset. For instance, the detected sound may indicate that a user is changing the tightness of a strap (e.g., listening to the sound associated with changing a dial setting, opening Velcro, . . . ).

Different techniques can be used to detect user adjustment events, which may be referred to herein as a “user adjustments”, involving the headset and determining whether the user adjustments are associated with a fitment issue. According to some configurations, the sensor data can be analyzed using techniques such as but not limited to time series analysis, statistical analysis, anomaly detection, machine learning algorithms, signal processing techniques, and the like may be used to detect user adjustments and fitment issues. In some examples, one or more ML models can be trained to receive sensor data from one or more sensors (e.g., IMU(s), cameras, sound sensors, light sensors, pressure sensors, . . . ), determine user adjustment events based on the sensor data, and determine whether any fitment issues exist based on the sensor data and/or adjustment events. In some examples, when a fitment issue is detected, the headset provides the user with a notification, such as a recommendation associated with addressing the determined fitment issue.

In some examples, the recommendation may inform the user to make various adjustments (e.g., tightening/loosening the strap) to the headset, change a component of headset (e.g., change light seal to a different size, change light seal cushion to a different thickness, change to a different sized nosepiece, change to a different sized strap, . . . ), provide additional information about adjustments that can be made to the headset (e.g., directing the user to a website or some other resource), and the like. According to some examples, the notifications can be presented on a display of the headset (e.g., a pop-up notification or some other type of user interface (UI) element).

As an example, if the analysis of the sensor data (e.g. from one or more pressure/contact sensors, cameras) indicates that a strap of the headset is not tightened properly (e.g., below/above a threshold, head not positioned correctly in the headset), the recommendation presented by the headset device may be to tighten/loosen the strap. As another example, if the analysis of the sensor data (e.g. from one or more light sensors) indicates that too much light is entering the headset (e.g., below/above a threshold), the recommendation may be to replace the light seal with a different light seal. Similarly, if the analysis of the sensor data (e.g., from one or more cameras and/or other ranging sensors) indicates that the headset is too low or too high on the user's face, the recommendation may be to replace a nosepiece with a different sized nosepiece, adjust one or more bands, or some other recommendation (e.g., access documentation regarding proper fit of the headset).

Examples of the present disclosure provide a number of advantages/benefits. For example, using sensor data and user adjustments to detect fitment issues of a headset can result in more comfort for a user and a better immersive experience for the user.

### I. Headset Overview

In the following disclosure, a physical environment refers to a physical world that people can sense and/or interact with without aid of electronic devices. The physical environment may include physical features such as a physical surface or a physical object. For example, the term physical environment may correspond to a physical park that includes physical trees, physical buildings, and physical people. People can directly sense and/or interact with the physical environment such as through sight, touch, hearing, taste, and smell. In contrast, an XR environment refers to a wholly or partially simulated environment that people sense and/or interact with via an electronic device. For example, the XR environment may include Augmented Reality (AR) content, Mixed Reality (MR) content, Virtual Reality (VR) content, and/or the like. With an XR system, a subset of a person's physical motions, or representations are tracked, and in response, one or more characteristics of one or more virtual objects simulated in the XR environment, are adjusted in a manner that comports with at least one law of physics.

As an example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and adjust graphical content and an acoustic field presented to the person in a manner, similar to how such views and sounds would change in a physical environment. In some situations (e.g., for accessibility reasons), the XR system may adjust characteristic(s) of graphical content in the XR environment in response to representations of physical motions (e.g., vocal commands).

According to some examples, a user interacts with an XR environment using a headset that includes an integrated display. In some cases, a head-mountable system may be configured to accept an external opaque display (e.g., a smartphone). The head-mountable system may incorporate one or more imaging sensors (e.g., cameras) to capture images or video of the physical environment, and/or one or more microphones to capture audio of the physical environment. Rather than an opaque display, a head-mountable system may have a transparent or translucent display. The transparent or translucent display may have a medium through which light representative of images is directed to a person's eyes.

The display may utilize digital light projection, OLEDs, LEDs, uLEDs, liquid crystal on silicon, laser scanning light source, or any combination of these technologies The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram, or on a physical surface.

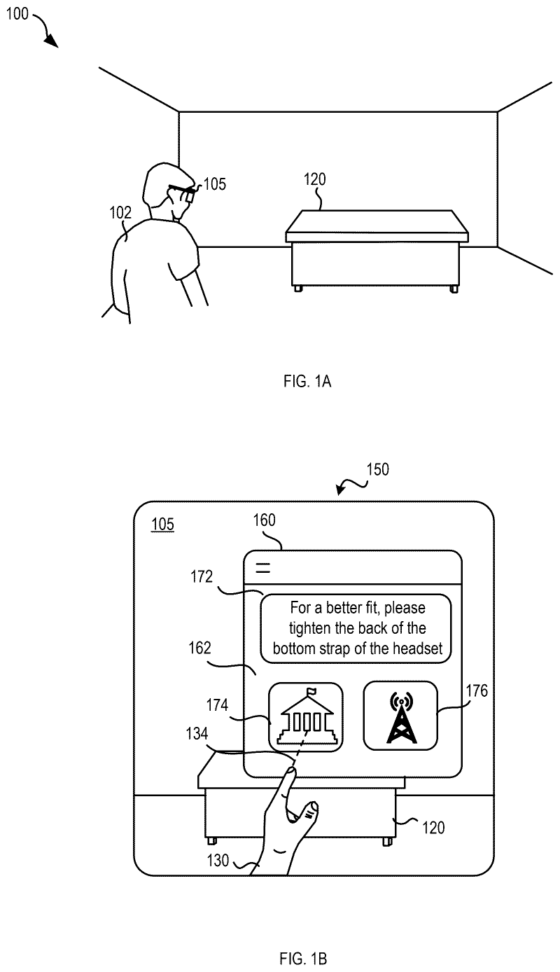

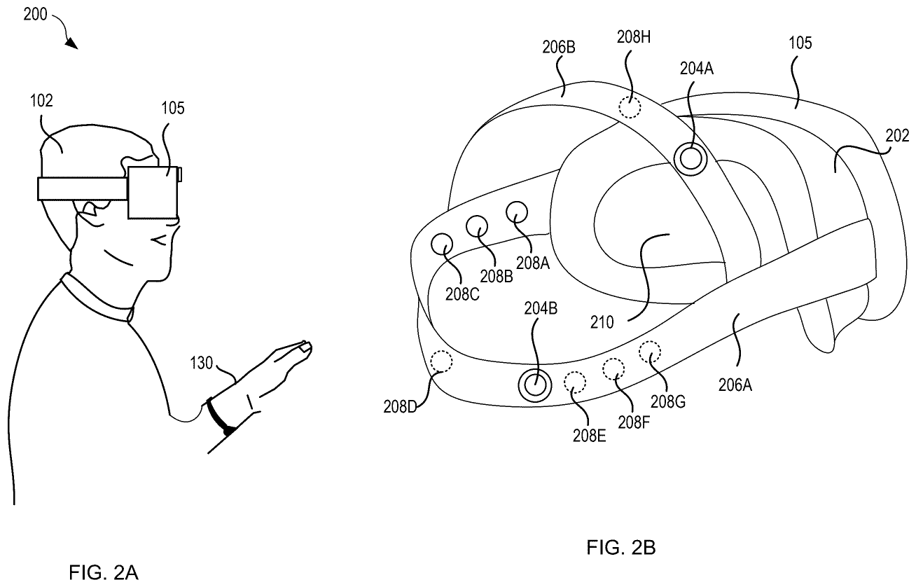

FIGS. 1A, 1B, and 2 provide an overview of the functions of an example electronic headset device 105 (e.g., a wearable device such as a head-mounted display (HMD) or a headset) and how a user can interact with the electronic headset device.

FIG. 1A is a diagram illustrating an example electronic headset device 105 operating in a physical environment, in accordance with some examples. The electronic headset device 105, which may be referred to herein as a “headset”, may include one or more cameras, microphones, depth sensors, pressure sensors, touch sensors, light sensors, or other sensors that can be used to capture information (e.g., images, sound, lighting characteristics, etc.) about and evaluate the physical environment 100 and the objects within it, as well as information about the user 102, and detection of fitment issues associated with the headset 105. The information about the physical environment 100 and/or user 102 may be used to provide visual and audio content and/or to identify the current location of the physical environment 100 (e.g., including locations of objects, such as the electronic device 120, the desk 125, in the physical environment 100) and/or the location of the user within the physical environment 100.

In some implementations, views of an extended reality (XR) environment may be provided to one or more participants (e.g., user 102 and/or other participants not shown) via headset 105. XR may be an umbrella term that covers virtual reality (VR), augmented reality (AR), mixed reality (MR), and the like. Such an XR environment may include views of a 3D environment that are generated based on camera images and/or depth camera images of the physical environment 100, as well as a representation of user 102 based on camera images and/or depth camera images of the user 102. Such an XR environment may include virtual content that is positioned at 3D locations relative to a 3D coordinate system (i.e., a 3D space) associated with the XR environment, which may correspond to a 3D coordinate system of the physical environment 100.

FIG. 1B is a diagram illustrating a view, provided via an electronic headset device 105, of virtual elements within the 3D physical environment of FIG. 1A, in accordance with some examples.

In this example, the user 102 may use a hand to hold the electronic device 120. The views 150 of the XR environment include a depiction of the user's hand 130 holding the electronic device 120 (i.e., an example of real content). In some examples, the views 150 may include a user interface (not shown). Providing such a view may involve determining 3D attributes of the physical environment 100 above (e.g., a position of the electronic device 120 in the physical environment 100, a size of the desk 120, a size of the physical environment 100, etc.) and positioning the virtual content, for example, a user interface 160, in a 3D coordinate system corresponding to that physical environment 100. In some examples, the user interface can include various content items, including a display of user interface (UI) elements. The user interface may be a user interface of an application, as illustrated in this example.

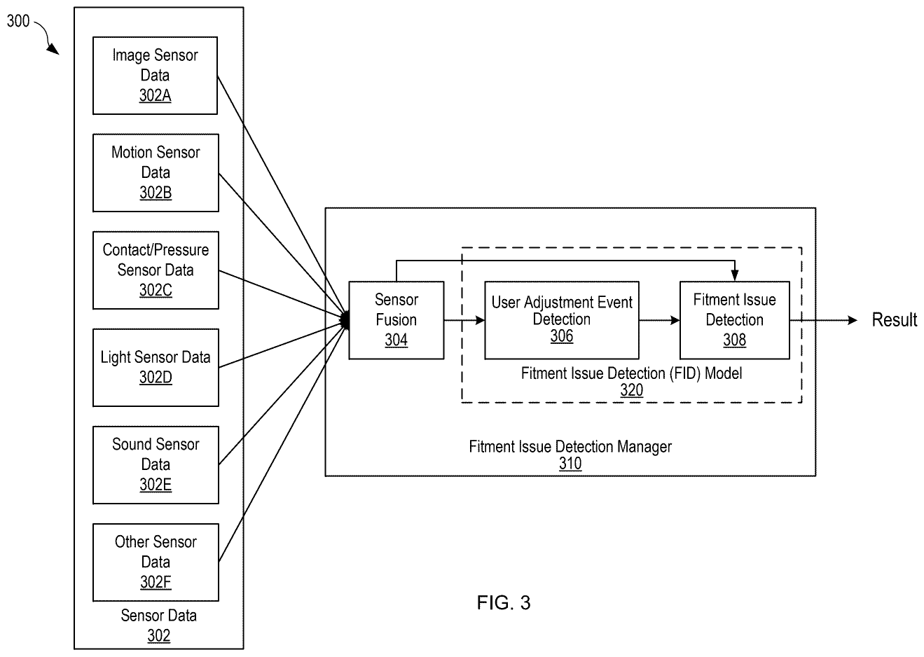

In the illustrated example, the UI element 172 is a recommendation that is provided in response to a fitment issue being detected by the headset 105. As briefly discussed above, and in more detail with regard to FIGS. 3-8, the recommendation may inform the user to make various adjustments (e.g., tightening/loosening a strap) to the headset, change a component of headset (e.g., change light seal to a different size, change to a different sized nosepiece, change to a different sized strap, . . . ), provide additional information about adjustments that can be made to the headset (e.g., directing the user to a website or some other resource), and the like. In the current example, the recommendation presented UI element 172 informs the user to tighten the back of the bottom strap of the headset 105.

The user interface 160 is simplified for purposes of illustration and user interfaces in practice may include any degree of complexity, any number of content items, and/or combinations of 2D and/or 3D content. The user interface 160 may be provided by operating systems and/or applications of various types including, but not limited to, messaging applications, web browser applications, content viewing applications, content creation and editing applications, or any other applications that can display, present, or otherwise use visual and/or audio content.

FIG. 2A is a diagram illustrating a user wearing an electronic headset device 105, in accordance with some examples. In this example, the user 102 may view and interact with an XR environment that includes the user interface 160 by using hands, such as hand 130, a controller, and/or some other type of input (e.g., voice). The headset 105 can include a different type of sensors, such as but not limited to one or more imaging sensors (e.g., cameras), sound sensors (e.g., microphones), contact/pressure sensors, touch sensors, light sensors, or other sensors that can be used to capture information (e.g., images, sound, lighting characteristics, etc.). In some examples, the headset 105 detects possible fitment issues based on user adjustment events and the sensor data.

In some configurations, a fitment issue can be determined based on a series of measures that can be used to determine one or more contact measures between the head of the user and the headset device. As used herein, the term “contact measure” may refer to a measurement determined from one or more sensors that indicates an amount/level of contact between one or more surfaces of the headset and the head of the user. According to some examples, contact measures can be determined from the series of measurements obtained from one or more sensors that determine contact/pressure at one or more points of the headset.

According to examples, a user may perform a user adjustment that causes a change in the fit of the headset on the head of the user. In particular, the user adjustment may cause a change in a spatial relationship between one or more of the user's eyes and one or more predefined target regions for the eyes. According to one or more examples, the target region may include one or more regions in space in front of the headset which, when the eyes are positioned within the region, provide an improved experience, for example, based on improved functionality of headset features such as gaze detection, or display characteristics on a display device of the headset. The target region may be predefined based on the headset and/or one or more applications or configurations of the headset. In some examples, the region may be defined as a geometric portion of space and may include one region for each eye, or a region for both eyes. According to some configurations, the headset 105 can be configured to perform eye tracking and determine whether the eyes of the user are positioned within a target region.

In some examples, the headset 105 can determine a corrective action which would result in the eyes falling within (or approaching) the target region(s). Examples of corrective actions include directional adjustment of the headset on a user's head, such as moving the device closer to the user's eyes, farther from the user's eyes, tilting the device, or the like. where sensor data is obtained corresponding to the eye location, such as the eye position. The sensor data may be obtained, for example, in conjunction with eye tracking functionality of the headset, or the like. In some examples, the headset may include one or more sensors, such as cameras, depth sensors, or the like, which are configured to detect the placement of an eye in front of the display of the headset. For example, the sensor data from the sensors can be used to detect when the user is wearing the headset, and/or the position of the eyes relative to the target region(s). Stated another way, the sensor data may be used to determine when the user is wearing the device and may be collected by one or more sensors on or in the device.

In some examples, the headset 105 may perform a lookup operation to identify a corrective accessory for the headset to improve the fit. That is, the device may access a data structure which associates a spatial relationship and/or offset of one or more eyes from a target region to corrective accessories. For instance, the headset 105 may determine that based on the sensor data, the headset 105 is too close to the eyes of user 102 and provide a recommendation to change a light seal (e.g., see element 202 of FIG. 2B). In some configurations, as discussed in more detail in FIGS. 3-8, the detection of the user adjustment events, the detection of the possible fitment issues, and the recommendations can be generated by one or more machine learning models.

In some examples, the device 105 may utilize the device fit parameters and perform a look up against a data structure comprising data regarding available adjustment components for the device. As used herein, a “device fit parameter” refers to a value, or a range of values that indicate a proper fit associated with different characteristics of the headset 105. According to some configurations, such data structure may be locally stored or may be remote. The available adjustable components for the headset may include adjustable components which, when adjusted, cause a change in the relative position of the headset 105. For instance, adjusting a tightness of a strap of the headset 105 may cause the eyes of the user to move closer/farther to/from the display of the device, and/or the eye or eyes to move relative to the predefined region associated with the device 150. The adjustment of the available adjustable components may result in a more or less comfortable fit for the user 102. Examples of adjustable components include light seals, nose bridge components, adjustable earpieces, adjustable straps, and the like.

A headset capable of generating XR environment for user interaction discussed above may have many potential benefits and applications, including, but not limited to, entertainment and gaming, training and education, indoor and outdoor navigation, health care and medical applications, etc.

FIG. 2B is a diagram illustrating an electronic headset device 105, in accordance with some examples. As illustrated, headset 105 includes a display 210, a light seal 202, sensor strap 206A, sensor strap 206B, strap fit adjuster/sensor 204A, strap fit adjuster/sensor 204B, and sensors 208, such as sensors 208A-208F. A headset 105 may include fewer or more sensors. The sensors 208 used can include, but are not limited to, inertial measurement units (IMUs), cameras, pressure sensors, light sensors, touch sensors, sound sensors, and the like. In the headset 105 illustrated in FIG. 2B, the sensors include cameras (not shown), contact/pressure sensors 208A-208H, and in some examples, strap fit adjuster/sensor 204A and strap fit adjuster/sensor 204B that indicate a setting that indicates tightness of a strap 206 of the headset 105. In some examples, the strap fit adjuster/sensor 204A and the strap fit adjuster/sensor 204B, and/or the contact/pressure sensors 208A-208H located at one or more locations of the strap 206A and/or strap 206B can be used to determine contact measures. While not illustrated, other sensors (not shown) can also be used to determine contact measures, according to other examples.

The headset 105 may include circuitry and/or software that, when executed, implement one or more machine learning models and other functionality. A “machine learning model” (ML model) can refer to a software module configured to be run on one or more processors to provide a classification or numerical value of a property of one or more samples. An ML model can include various parameters (e.g., for coefficients, weights, thresholds, functional properties of function, such as activation functions). As examples, an ML model can include at least 10, 100, 1,000, 5,000, 10,000, 50,000, 100,000, or more than a billion parameters. An ML model can be generated using sample data (e.g., training samples) to make predictions on test data. Various number of training samples can be used, e.g., at least 10, 100, 1,000, 5,000, 10,000, 50,000, 100,000, or at least 200,000 training samples. One example is an unsupervised learning model. Another example type of model is supervised learning that can be used with examples of the present disclosure. Example supervised learning models may include different approaches and algorithms including analytical learning, statistical models, artificial neural network, backpropagation, boosting (meta-algorithm), Bayesian statistics, case-based reasoning, decision tree learning, inductive logic programming, Gaussian process regression, genetic programming, group method of data handling, kernel estimators, learning automata, learning classifier systems, minimum message length (decision trees, decision graphs, etc.), multilinear subspace learning, naive Bayes classifier, maximum entropy classifier, conditional random field, nearest neighbor algorithm, probably approximately correct learning (PAC) learning, ripple down rules, a knowledge acquisition methodology, symbolic machine learning algorithms, subsymbolic machine learning algorithms, minimum complexity machines (MCM), random forests, ensembles of classifiers, ordinal classification, data pre-processing, handling imbalanced datasets, statistical relational learning, or Proaftn, a multicriteria classification algorithm. The model may include linear regression, logistic regression, deep recurrent neural network (e.g., long short-term memory, LSTM), hidden Markov model (HMM), linear discriminant analysis (LDA), k-means clustering, density-based spatial clustering of applications with noise (DBSCAN), random forest algorithm, support vector machine (SVM), or any model described herein. Supervised learning models can be trained in various ways using various cost/loss functions that define the error from the known label (e.g., least squares and absolute difference from known classification) and various optimization techniques, e.g., using backpropagation, steepest descent, conjugate gradient, and Newton and quasi-Newton techniques.

### II. Fitment Issue Detection

FIG. 3 is a diagram illustrating an example architecture of detecting fitment issues, in accordance with some examples. As illustrated, FIG. 3 includes sensor data 303, and fitment issue detection (FID) manager 310. According to some configurations, to determine a possible fitment issue of a headset, sensor data and user adjustment events can be obtained and analyzed. In some examples, a fitment issue detection (FID) machine learning model (ML) 320, which can be referred to herein as “FID model”, can be utilized. Additionally, sensors 208 in the headset 105 can be used to increase the accuracy of the detection of a possible fitment issue. The FID model 320 may have several pipeline stages.

A sensor fusion network 304 may be configured to receive sensor data 302 from one or more sensors 208 as inputs and provide sensor data 302 to user adjustment event detection component 306. As briefly discussed above, many different types of sensors may be used to detect user adjustments of the headset 105 and determine a possible fitment issue of a headset 105. For instance, a headset 105 may include one or more cameras that provide image sensor data 302A. In some configurations, a headset 105 may include one or more motion sensors (e.g., IMUs, gyroscopic sensors, and the like) that provide motion sensor data 302B. The headset 105 can also include one or more contact sensors, touch sensors and/or pressure sensors that provide contact/pressure sensor data 302C.

As briefly discussed above, a fitment issue can be determined based on a series of measures that can be used to determine one or more contact measures between the head of the user and the headset device. According to some examples, contact measures can be determined from the series of measurements obtained from one or more sensors that provide contact/pressure sensor data 302C. According to some configurations, the headset 105 may include one or more light sensors that provide light sensor data 302D. In some examples, the headset 105 may include one or more sound sensors (e.g., one or more microphones) that provide sound sensor data 302E. In some configurations, the headset 105 can include other types of sensors (e.g., temperature sensors, other type of imaging sensors, . . . ) that provide other sensor data 302F. Sensor fusion network 304 receives this sensor data and provides at least a portion of the sensor data to user adjustment event detection component 306. The user adjustment event detection component 306 is configured to detect a user adjustment of the headset 105 made by the user 102.

### A. User Adjustment Event Detection

Different techniques can be used to detect user adjustment events involving the headset 105 and determining whether the user adjustments are associated with a fitment issue. According to some configurations, the sensor data 302 can be analyzed using techniques such as but not limited to time series analysis, statistical analysis, anomaly detection, machine learning algorithms, signal processing techniques, and the like may be used to detect user adjustments and fitment issues. In some examples, one or more ML models, such as FID model 320, can be trained to receive sensor data 302 from one or more sensors of the headset 105 (e.g., IMU(s), cameras, sound sensors, light sensors, pressure sensors, contact sensors . . . ), and based on the sensor data determine user adjustment events.

According to some configurations, the headset may include one or more contact sensors, touch sensors and/or pressure sensors. In some examples, sensor data 302 obtained from sensors of the headset 105 may be used to determine a user adjustment that is associated with a quality of fit of the headset. As an example, contact/pressure sensor data 302C from contact/pressure sensors located on one or more straps of a headset (e.g., solo loop band or dual loop band), can be analyzed to detect a change in contact and/or pressure with a user's head. In some configurations, the contact/pressure sensors can be located on the headset 105 such that contact/pressure data can be measured for different locations of the user's head (e.g., front, back, left and right sides of the head, top, bottom, sides of the face, . . . ).

Movement sensor data 302B can be also used to detect a user adjustment, such as when the user 102 places the headset 105 on their head, when the user 102 removes the headset 105, when the headset 105 moves, and the like. The movement sensor data 302B can also be used to detect distinct user adjustment patterns (e.g., a user pushes-up on the headset, acceleration of the headset in a particular direction), a user's head position (e.g., tilted up/down), and the like. Light sensor data 302D can be used to determine a change in how much light is entering the headset and when there is a change in the light level detecting a user adjustment. Sound sensor data 302E can also be used to determine when a user is making a user adjustment to the headset. For instance, the detected sound may indicate that a user is changing the tightness of a strap (e.g., listening to the sound associated with changing a dial setting, opening Velcro, . . . ). In some configurations, a combination of different sensor data 302 can be used to detect a user adjustment. For example, sound sensor data may indicate a user adjusting a strap of the headset, and light sensor data 302D may indicate that the adjustment resulted in more light entering the headset 105. According to some configurations, a ML model is trained to detect user adjustment events.

### B. Fitment Issue Detection

Different techniques can be used to detect possible fitment issues involving the headset 105. According to some configurations, the sensor data 302 can be analyzed to detect a fitment issue using techniques such as but not limited to time series analysis, statistical analysis, anomaly detection, machine learning algorithms, signal processing techniques, and the like may be used to detect fitment issues. In some examples, one or more ML models, such as FID model 320, can be trained to receive sensor data 302 from one or more sensors of the headset 105 (e.g., IMU(s), cameras, sound sensors, light sensors, pressure sensors, contact sensors . . . ), and based on the sensor data detect a possible fitment issue.

Fitment issue detection component 308 can be configured to determine when a possible fitment issue is detected in response to one or more contact measures, and/or user adjustments (e.g., a single user adjustment and/or a number of user adjustments made within a specified period of time). As discussed above, a detection of a possible fitment issue may indicate that the headset 105 is improperly positioned on the head of a user (e.g., eyes are improperly positioned relative to the display), too much light is entering the headset (e.g., a strap of the headset not tightened properly, light seal not the correct size), the headset is uncomfortable (e.g., user keeps taking on/off the headset, adjusting straps, changing position of the headset, . . . ), the headset keeps sliding down the nose of the user (e.g., nosepiece is not the correct size), and the like.

For instance, the fitment issue detection component 308 can receive and analyze image sensor data 302 to detect a position of the user's head within the headset. As an example, one or more eye tracking cameras of the headset 105 can be used to determine whether the distance between the user's eyes and display of the headset 105 is the specified distance. Image sensor data 302A can also be used to determine whether the user is wearing the headset 105 too high or too low (e.g., by measuring a vertical eye offset), determine whether the headset 105 is moving down the user's face over a period of time, and the like. Image sensor data 302 can also be analyzed to detect whether the user's hands are touching the headset 105 for adjustment purposes, and be used to determine the frequency of such adjustments.

In some configurations, motion sensor data 302B can be analyzed by the FID manager 310 to detect when the user 102 places the headset 105 on their head, when the user 102 removes the headset 105, when the headset 105 moves, and the like. The movement sensor data 302B can also be analyzed by the FID manager 310 to detect distinct adjustment patterns (e.g., a user pushes-up on the headset, acceleration of the headset in a particular direction), a user's head position (e.g., tilted up/down), and the like.

According to some configurations, the contact/pressure sensor data 302C from the headset 105 can be analyzed by the FID manager 310 to detect contact and/or pressure with a user's head. In some configurations, the contact/pressure sensor data 302C indicates contact/pressure measurements for different portions of the user's head (e.g., front, back, left and right sides of the head, top, bottom, sides of the face, . . . ). In some examples, the fitment issue detection component 308 detects a fitment issue based on the contact/pressure sensor data 302C. As a particular example, a determination can be made as to whether all/portion of the sensors (e.g., 6 out of 10 sensors, 4 out of 5 sensors, . . . ) have measured a specified amount of contact/pressure against the head. As another example, the contact/pressure sensor data 302C may indicate that only one side, and/or top, of the head is in contact with the headset.

According to some configurations, the fitment issue detection component 308 detects a fitment issue based on the light sensor data 302D. The light sensor data 302D can be analyzed to determine how much light is entering the headset 105 and when there is too much light is entering the headset (e.g., above a threshold). Too much light entering the headset 105 may indicate that the light seal should be replaced with a different size of light seal and/or that one or more straps is not tightened enough to reduce the amount of light entering the headset.

According to some configurations, the fitment issue detection component 308 generates one or more notifications/recommendations to present to the user 102 in response to detecting a fitment issue. In some examples, the recommendation may inform the user to make various adjustments (e.g., tightening/loosening the strap) to the headset, change a component of headset (e.g., change light seal to a different size, change to a different sized nosepiece, change to a different sized strap, . . . ), provide additional information about adjustments that can be made to the headset (e.g., directing the user to a website or some other resource), and the like. According to some examples, the notifications can be audibly presented and/or presented on a display of the headset (e.g., a pop-up notification or some other type of user interface (UI) element).

As an example, if the analysis of the sensor data 302 by the fitment issue detection component 308 indicates that a strap of the headset is not tightened properly (e.g., below/above a threshold, head not positioned correctly in the headset), the recommendation may be to tighten/loosen the strap. As another example, if the analysis of the sensor data (e.g. from one or more light sensors) indicates that too much light is entering the headset (e.g., below/above a threshold), the recommendation may be to replace the light seal with a different light seal. Similarly, if the analysis of the sensor data (e.g., from one or more cameras and/or other ranging sensors) indicates that the headset is too low or too high on the user's face, the recommendation may be to replace a nosepiece with a different sized nosepiece, adjust one or more bands, or some other recommendation (e.g., access documentation regarding proper fit of the headset).

### III. Machine Learning Model for Fitment Issue Detection

As briefly described above, one or more machine learning (ML) models can be used to detect user adjustment events and determine possible fitment issues. In some examples, the FID model 320 can include sub-models that use various techniques, such as visual detection (e.g., image processing and computer vision), motion detection, light detection, sound detection, pressure/contact detection, machine learning models, and the like.

The FID model 320 can be a machine learning model that is trained to use sensor data 302 obtained from one or more sensors associated with a headset 105. The FID model 320 can be trained using training data associated with user adjustments and fitment issues obtained from different users (when the different users have opted in to allowing use of the data). The training data may include real sensor data and/or synthetic training data. In some examples, the training data includes sensor data from can include but are not limited to inertial measurement units (IMUs), cameras, pressure sensors, light sensors, touch sensors, sound sensors, and the like.

The FID model 320 may involve performing visual detection (e.g., using image sensors), audio detection (e.g., using sound sensors), contact/pressure detection (e.g., using contact/pressure sensors), light detection (e.g., using light sensors), and motion detection (e.g., using motion sensors, such as IMUs, gyroscopes, accelerometers, . . . ) that can be combined or fused together by sensor fusion network 304 that can be used by user adjustment event detection component 306 to detect a user adjustment of the headset and by fitment issue detection component 308 detect a fitment issue with the headset 105.

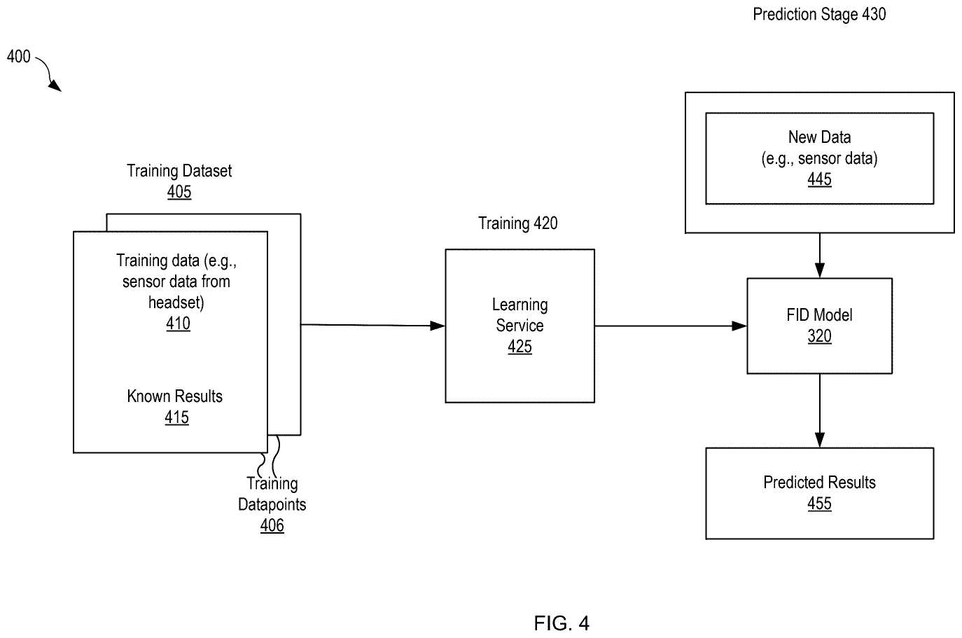

FIG. 4 illustrates an example architecture for training one or more machine learning models to detect user adjustment events and possible fitment issues based on user adjustments and sensor data, in accordance with some examples. In FIG. 4, a training dataset 405 comprises multiple training datapoints 406. Each training datapoint 406 may include training data 410, such as sensor data obtained from one or more sensors of the headset, and corresponding known results 415 (or called ground truth). The known results 415 may include an indication of whether particular sensor data indicates a fitment issue and/or a user adjustment event.

The training datapoints 406 can be used by a learning service 425 to perform training 420. A service, such as learning service 425, is one or more computing devices configured to execute computer code to perform one or more operations that make up the service. Learning service 425 can optimize parameters of an FID model 320 such that a quality metric (e.g., accuracy of FID model 320) is achieved with one or more specified criteria. The accuracy may be measured by comparing known results 415 to predicted results. Parameters of FID model 320 can be iteratively varied to increase accuracy. Determining a quality metric can be implemented for any arbitrary function, including the set of all risk, loss, utility, and decision functions.

In some examples of training, a gradient may be determined for how varying the parameters affects a cost function, which can provide a measure of how accurate the current state of the machine learning model is. The gradient can be used in conjunction with a learning step (e.g., a measure of how much the parameters of the model should be updated for a given time step of the optimization process). The parameters (which can include weights, matrix transformations, and probability distributions) can thus be optimized to provide an optimal value of the cost function, which can be measured as being above or below a threshold (i.e., exceeds a threshold) or that the cost function does not change significantly for several time steps, as examples. In other examples, training can be implemented with methods that do not require a hessian or gradient calculation, such as dynamic programming or evolutionary algorithms.

A prediction stage 430 can provide a predicted result 455 for new data 445. The predicted result 455 can be a predicted determination of whether an adjustment event is detected and/or a fitment issue is detected. The new data can be of a similar type as training data 410. If new data is of a different type, a transformation can be performed on the data to obtain data in a similar format as training data 410.

Examples of machine learning models include deep learning models, neural networks (e.g., deep learning neural networks), kernel-based regressions, adaptive basis regression or classification, Bayesian methods, ensemble methods, logistic regression and extensions, Gaussian processes, support vector machines (SVMs), a probabilistic model, and a probabilistic graphical model. Examples using neural networks can employ using wide and tensorized deep architectures, convolutional layers, dropout, various neural activations, and regularization steps.

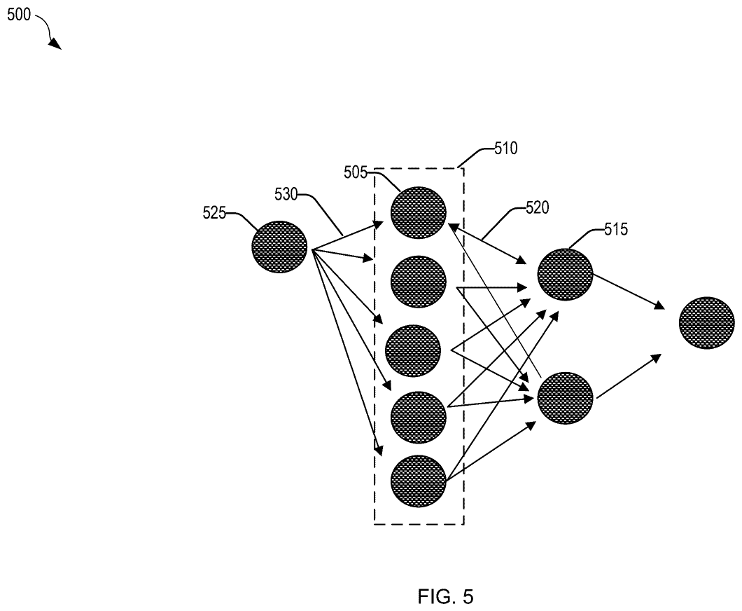

FIG. 5 illustrates an example machine learning model of a neural network, in accordance with some examples. As an example, model 500 can be a neural network that comprises a number of neurons (e.g., Adaptive basis functions) organized in layers. For example, neuron 505 can be part of layer 510. The neurons can be connected by edges between neurons. For example, neuron 505 can be connected to neuron 515 by edge 520. A neuron can be connected to any number of different neurons in any number of layers. For instance, neuron 805 can be connected to neuron 525 by edge 530 in addition to being connected to neuron 515.

The training of the neural network can iteratively search for the best configuration of the parameter of the neural network for feature recognition and prediction performance. Various numbers of layers and nodes may be used. A person with skills in the art can easily recognize variations in a neural network design and design of other machine learning models. For example, neural networks can include graph neural networks that are configured to operate on unstructured data. A graph neural network can receive a graph (e.g., nodes connected by edges) as an input to the model and the graph neural network can learn the features of this input through pairwise message passing. In pairwise message passing, nodes exchange information and each node iteratively updates its representation based on the passed information.

### IV. Detecting Fitment Issue Using One or More Sensors

In some configurations, a fitment issue can be determined using one or more sensors. According to some configurations, after detecting that the user has placed the headset on their head, sensor data can be obtained from one or more sensors of the headset. The sensor data can be used to detect when the user makes an adjustment to the headset and/or when there is a fitment issue with the headset. When a fitment issue is detected, a notification can be provided to the user indicating a quality of fit of the headset for the user.

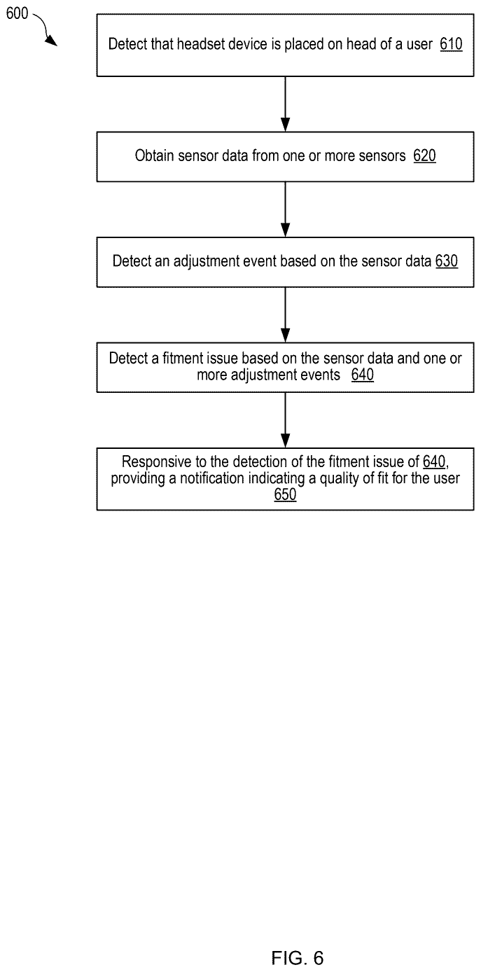

FIG. 6 is a flowchart illustrating a method for detecting fitment issues of a headset 105 based on user adjustments detected using one or more sensors, in accordance with some examples. The processing depicted in FIG. 6 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 6 and described below is intended to be illustrative and non-limiting. Although FIG. 6 depicts the various processing steps occurring in a particular sequence or order, this is not intended to be limiting. In certain alternative examples, the processing may be performed in some different order, or some steps may also be performed in parallel. It should be appreciated that in alternative examples, the processing depicted in FIG. 6 may include a greater number or a lesser number of steps than those depicted in FIG. 6.

At 610, a headset (e.g., 105) is detected being placed on a head of the user 102. As discussed above, different techniques can be used to detect that the headset 105 is placed on the head of the user using one or more sensors 208 of the headset. For instance, the FID manager 310 may obtain sensor data from a camera of the headset to identify that a user has placed their head in the headset and/or taken off the headset. In some examples, the user can be identified by the headset 105 using one or more techniques (when authorized by the user), such as using biometrics associated with (e.g., iris identification, fingerprint, voice, face recognition, . . . ). In some examples, iris identification can be used to detect that a user 102 has placed the headset on their head.

At 620, sensor data from one or more sensors of the headset are obtained. As discussed above, sensor data 302 may come from one or more sensors, such as but not limited to inertial measurement units (IMUs), image sensors (e.g., cameras), pressure sensors, light sensors, touch sensors, sound sensors (e.g., microphones), and the like.

At 630, an adjustment event based on the sensor data is detected. As discussed above, a user adjustment event detection component 306 can detect an adjustment event in response to determining that a user 102 has made an adjustment to the headset 105. For example, sensor data 302 from cameras and other sensors (e.g., contact/pressure/touch sensors, . . . ) can be used to detect when the user places the headset 105 on their head, when the user removes the headset 105, when the user places their hand on the headset 105 thereby causing the headset to be repositioned on the user's head, and the like. The sensor data 302 can also be used to detect distinct adjustment patterns (e.g., a user pushes-up on the headset, acceleration of the headset in a particular direction), a user's head position (e.g., tilted up/down), and the like.

Sensor data 302 associated with an adjustment of one or more straps of a headset can also be analyzed to detect contact and/or pressure with a user's head. In some configurations, the sensors can be located on the headset 105 such that contact/pressure data can be obtained for different portions of the user's head (e.g., front, back, left and right sides of the head, top, bottom, sides of the face, . . . ). Sensor data 302 from sound sensors can also be used to determine when a user is making a user adjustment to the headset 105. For instance, the detected sound may indicate that a user 102 is changing the tightness of a strap (e.g., listening to the sound associated with changing a dial setting, opening Velcro, . . . ). Other sensor data 302 (e.g., sensor data from light sensors) can be used to detect an adjustment event.

At 640, a fitment issue based on the sensor data and one or more adjustment events is detected. As discussed above, a fitment issue can be detected by a fitment issue detection component 308, based on sensor data 302 that indicates that the headset 105 is improperly positioned on the head of a user (e.g., camera sensor data indicates eyes are improperly positioned relative to the display), too much light is entering the headset (e.g., pressure/contact sensor data indicates strap(s) of headset not tightened properly, and/or light sensor data indicates light entering exceeds a threshold). In some examples, the headset 105 (e.g., using fitment issue detection manager 310) can detect that the headset may be uncomfortable (e.g., sensor data over a period of time indicates that the user keeps taking on/off the headset, adjusting straps, changing position of the headset, . . . ), the headset keeps sliding down the nose of the user (e.g., nosepiece is not the correct size), and the like. As described with regard to FIG. 6, a fitment issue can be determined based on the detected contact/pressure with the different sensors. Camera sensor data can also be used by the fitment issue detection component 308 to determine whether the user is wearing the headset too high or too low (e.g., by measuring a vertical eye offset), determine whether the headset is moving down the user's face over a period of time, and the like. Camera sensor data can also be used to detect whether the user's hands are touching the headset for adjustment purposes, and the frequency of such adjustments.

At 650, responsive to detecting a fitment issue, a notification is provided to the user. As discussed above, the fitment issue detection manager 310 can generate a notification that informs the user to make one or more adjustments (e.g., tightening/loosening the strap, positions of lenses) to the headset, change a component of headset (e.g., change light seal to a different size, change to a different sized nosepiece, change to a different sized strap, . . . ), provide additional information about adjustments that can be made to the headset (e.g., directing the user to a website or some other resource), and the like. According to some examples, the notifications can be presented on a display of the headset (e.g., a pop-up notification or some other type of user interface (UI) element).

### V. Detecting Fitment Issue Based on Contact Measures

In some configurations, a fitment issue can be determined based on one or more contact measures, e.g., as described for FIG. 2A, FIG. 2B, and section II.A. According to some configurations, after detecting that the user has placed the headset on their head, a series of measurements are performed by one or more sensors of the headset for contact between the headset and the head of the user. The series of measurements can be used to determine one or more contact measures between the head of the user and the headset device. The contact measurement(s) indicate contact between one or more surfaces of the headset and the head of the user. The contact measurement(s) can be compared to one or more device fit parameters to determine a quality of fit of the headset for the user.

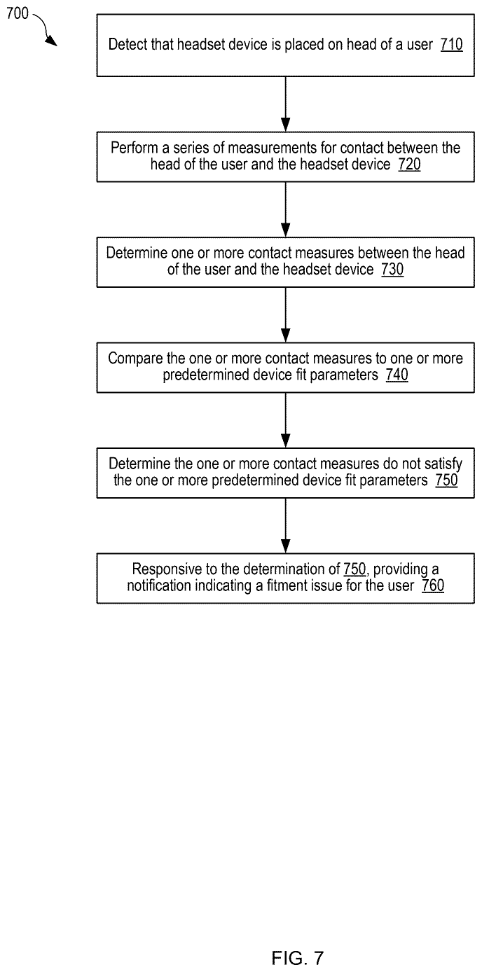

FIG. 7 is a flowchart illustrating a method for detecting fitment issues of a headset based on a series of measurements and user adjustments, in accordance with some examples. The processing depicted in FIG. 7 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 7 and described below is intended to be illustrative and non-limiting. Although FIG. 7 depicts the various processing steps occurring in a particular sequence or order, this is not intended to be limiting. In certain alternative examples, the processing may be performed in some different order, or some steps may also be performed in parallel. It should be appreciated that in alternative examples, the processing depicted in FIG. 7 may include a greater number or a lesser number of steps than those depicted in FIG. 7.

At 710, a headset 105 is detected being placed on a head of the user 102. As discussed above, different techniques can be used to detect that the headset 105 is placed on the head of the user using one or more sensors 208 of the headset. For instance, the FID manager 310 may obtain sensor data from a camera of the headset 105 to identify that a user has placed their head in the headset and/or taken off the headset 105. In some examples, the user can be identified by the headset 105 using one or more techniques (when authorized by the user), such as using biometrics associated with (e.g., iris identification, fingerprint, voice, face recognition, . . . ). In some examples, iris identification can be used to detect that a user 102 has placed the headset on their head.

At 720, a series of measurements for contact between a head of the user 102 and the headset 105 are performed. As discussed above, the headset 105 may perform a series of measurements using one or more sensors to determine whether the user's head is positioned correctly within the headset 105. As an example, sensor data 302 from contact/pressure sensors located on one or more straps of a headset (e.g., solo loop band or dual loop band), can be analyzed to detect contact and/or pressure with a user's head. In some configurations, the sensors can be located on the headset 105 such that contact/pressure data can be obtained for different portions of the user's head (e.g., front, back, left and right sides of the head, top, bottom, sides of the face, . . . ). Sensors can also be used to determine when a user is touching the headset (e.g., cameras, touch sensors, . . . ).

At 730, one or more contact measures between the head of the user and the headset 105 are determined. As discussed above, in some examples, the headset 105 can determine an amount of pressure at different portions of the user's head (e.g., front, back, left and right sides of the head, top, bottom, sides of the face, . . . ) from sensor data 302 obtained from one or more pressure sensors. In some configurations, camera sensor data can be used to determine position data that indicates a position of the user's head within the headset.

At 740, a comparison of the one or more contact measures to one or more predetermined device fit parameters is performed. In some examples, the FID manager 301 compares the one or more contact measures to one or more predetermined device fit parameters that specify preferred contact pressures (or range of contact pressures) at one or more locations around the user's head.

At 750, a determination is made that one or more contact measures do not satisfy the one or more predetermined device fit parameters is performed. As discussed above, a determination can be made by the FID manager 310 as to whether all/portion of the sensors (e.g., 6 out of 10 sensors, 4 out of 5 sensors, . . . ) have a specified amount of contact/pressure against the head. As another example, the headset 105 can identify that one or more contact measures do not satisfy a device fit parameter (e.g., a contact measurement may indicate that only one side, and/or top, of the head is in contact with the headset).

At 760, responsive to detecting a fitment issue, a notification is provided to the user 102. As discussed above, the notification may inform the user to make various adjustments (e.g., tightening/loosening the strap, positions of lenses) to the headset 105, change a component of headset 105 (e.g., change light seal to a different size, change to a different sized nosepiece, change to a different sized strap, . . . ), provide additional information about adjustments that can be made to the headset 105 (e.g., directing the user to a website or some other resource), and the like. According to some examples, the notifications can be presented on a display of the headset 105 (e.g., a pop-up notification or some other type of user interface (UI) element).

### VI. Detecting Fitment Issue Based on Repeated User Adjustments

In some configurations, a fitment issue can be determined based on repeated user adjustments made to the headset, e.g., as described in section II.A. According to some configurations, after detecting that the user has placed the headset on their head, a series of measurements are performed by one or more sensors of the headset that indicate the user making an adjustment event to the headset. The series of measurements can be used to determine a change in the placement of the headset on the head of the user. When the number of adjustments made to the headset exceed a threshold, a notification can be provided to the user indicating a quality of fit of the headset for the user.

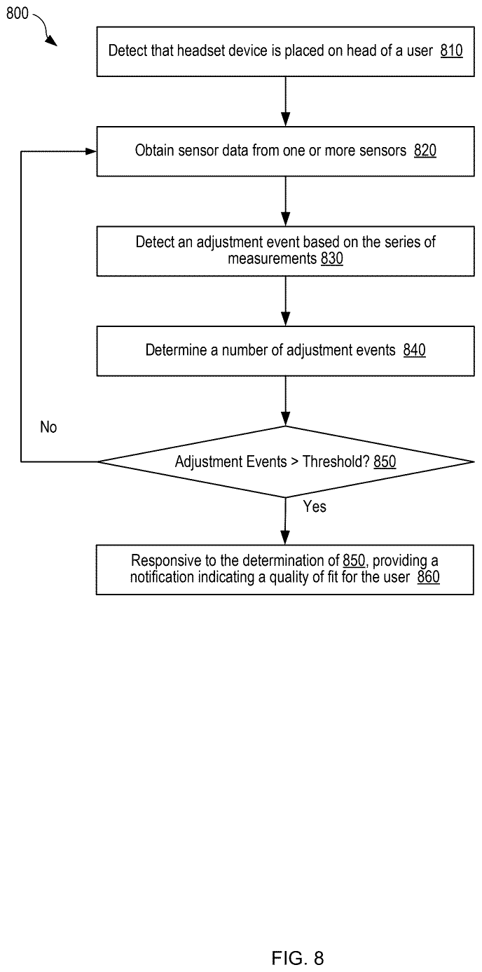

FIG. 8 is a flowchart illustrating a method for detecting fitment issues of a headset based on a number of user adjustments, in accordance with some examples. The processing depicted in FIG. 8 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 8 and described below is intended to be illustrative and non-limiting. Although FIG. 8 depicts the various processing steps occurring in a particular sequence or order, this is not intended to be limiting. In certain alternative examples, the processing may be performed in some different order or some steps may also be performed in parallel. It should be appreciated that in alternative examples, the processing depicted in FIG. 8 may include a greater number or a lesser number of steps than those depicted in FIG. 8.

At 810, a headset 105 is detected being placed on a head of the user 102. As discussed above, different techniques can be used to detect that the headset 105 is placed on the head of the user using one or more sensors 208 of the headset. For instance, the FID manager 310 may obtain sensor data from a camera of the headset 105 to identify that a user has placed their head in the headset and/or taken off the headset 105. In some examples, the user can be identified by the headset 105 using one or more techniques (when authorized by the user), such as using biometrics associated with (e.g., iris identification, fingerprint, voice, face recognition, . . . ). In some examples, iris identification can be used to detect that a user 102 has placed the headset on their head.

At 820, sensor data from one or more sensors of the headset 105 are obtained. As discussed above, sensor data 302 may come from one or more sensors, such as but not limited to inertial measurement units (IMUs), cameras, pressure sensors, light sensors, touch sensors, sound sensors, and the like.

At 830, an adjustment event based on the sensor data is detected. As discussed above, an adjustment event can be detected by the user adjustment event detection component 306 in response to determining that a user 102 has made an adjustment to a position of the headset 105. For example, sensor data 302 from cameras and other sensors (e.g., contact/pressure/touch sensors, . . . ) can be used to detect when the user places the headset 105 on their head, when the user removes the headset 105, when the user places their hand on the headset 105 causing it to move, and the like. The sensor data can also be used to detect distinct adjustment patterns (e.g., a user pushes-up on the headset 105, acceleration of the headset in a particular direction), a user's head position (e.g., tilted up/down), and the like. In some examples, a user adjustment event counter is incremented by the FID manager 310 in response to detecting the adjustment event.

At 840, a number of adjustment events is determined. As discussed above, the number of adjustment events can be used to determine if a user adjustment of the headset 105 indicates a possible fitment issue. In some examples, the number of adjustment events is determined for a specified period of time (e.g., one minute, five minutes, . . . ) and/or determined based on a current activity of the user (e.g., while the user is interacting with the same application).

At 850, a determination is made as to whether the number of adjustment events is greater than a threshold. As discussed above, the threshold can be based on data that indicates that the user adjustments are indicative of a fitment issue. As an example, the user taking on and off the headset frequently (e.g., more than once every minute, 5 minutes, . . . ) while interacting with content displayed within the headset may indicate an improper fit. In some configurations, the threshold can change based on different criteria, such as but not limited to whether the user interacting with the same application over the period of time, whether the user is changing applications, and the like. When the number of adjustment events is less than the threshold, the method returns to 820. When the number of adjustment events is greater than the threshold, the method moves to 860.

At 860, responsive to detecting a fitment issue based on the number of adjustment events, a notification is provided to the user. As discussed above, the notification may inform the user to make various adjustments (e.g., tightening/loosening the strap, positions of lenses) to the headset, change a component of headset (e.g., change light seal to a different size, change to a different sized nosepiece, change to a different sized strap, . . . ), provide additional information about adjustments that can be made to the headset (e.g., directing the user to a website or some other resource), and the like. According to some examples, the notifications can be presented on a display of the headset (e.g., a pop-up notification or some other type of user interface (UI) element).

### VII. Use of Artificial Intelligence

Some examples described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provider transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some examples, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some examples, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some examples, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some examples, the present disclosure contemplates that data used for AI/ML systems may be kept strictly separated from platforms where the AI/ML systems are deployed and/or used to interact with users and/or process data. In such examples, data used for offline training of the AI/ML systems may be maintained in secured datastores with restricted access and/or not be retained beyond the duration necessary for training purposes. In some examples, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some examples, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some examples, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some examples, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates examples in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

### VIII. Example Device

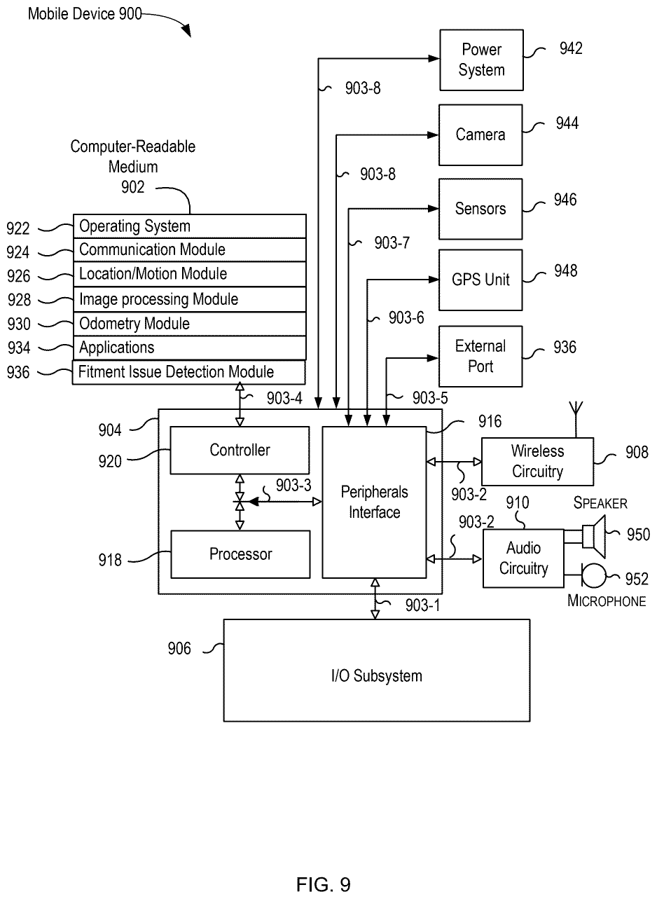

FIG. 9 is a block diagram of an example device 900, which may be a mobile device. Device 900 generally includes computer-readable medium 902, a processing system 904, an Input/Output (I/O) subsystem 906, wireless circuitry 908, and audio circuitry 910 including speaker 950 and microphone 952. These components may be coupled by one or more communication buses or signal lines 903. Device 900 can be any portable mobile device, including a handheld computer, a tablet computer, a mobile phone, laptop computer, tablet device, media player, personal digital assistant (PDA), a key fob, a car key, an access card, a multi-function device, a mobile phone, a portable gaming device, a car display unit, or the like, including a combination of two or more of these items.

It should be apparent that the architecture shown in FIG. 9 is only one example of an architecture for device 900, and that device 900 can have more or fewer components than shown, or a different configuration of components. The various components shown in FIG. 9 can be implemented in hardware, software, or a combination of both hardware and software, including one or more signal processing and/or application specific integrated circuits.

Wireless circuitry 908 is used to send and receive information over a wireless link or network to one or more other devices' conventional circuitry such as an antenna system, an RF transceiver, one or more amplifiers, a tuner, one or more oscillators, a digital signal processor, a CODEC chipset, memory, etc. Wireless circuitry 908 can use various protocols, e.g., as described herein.

Wireless circuitry 908 is coupled to processing system 904 via peripherals interface 916. Interface 916 can include conventional components for establishing and maintaining communication between peripherals and processing system 904. Voice and data information received by wireless circuitry 908 (e.g., in speech recognition or voice command applications) is sent to one or more processors 918 via peripherals interface 916. One or more processors 918 are configurable to process various data formats for one or more application programs 934 stored on medium 902.

Peripherals interface 916 couple the input and output peripherals of the device to processor 918 and computer-readable medium 902. One or more processors 918 communicate with computer-readable medium 902 via a controller 920. Computer-readable medium 902 can be any device or medium that can store code and/or data for use by one or more processors 918. Medium 902 can include a memory hierarchy, including cache, main memory, and secondary memory.

Device 900 also includes a power system 942 for powering the various hardware components. Power system 942 can include a power management system, one or more power sources (e.g., battery, alternating current (AC)), a recharging system, a power failure detection circuit, a power converter or inverter, a power status indicator (e.g., a light emitting diode (LED)), and any other components typically associated with the generation, management, and distribution of power in mobile devices.

In some examples, device 900 includes a camera 944. In some examples, device 900 includes sensors 946. Sensors 946 can include accelerometers, compasses, gyrometers, pressure sensors, audio sensors, light sensors, barometers, altimeter, and the like. Sensors 946 can be used to sense location aspects, such as auditory or light signatures of a location.

In some examples, device 900 can include a GPS receiver, sometimes referred to as a GPS unit 948. A mobile device can use a satellite navigation system, such as the Global Positioning System (GPS), to obtain position information, timing information, altitude, or other navigation information. During operation, the GPS unit can receive signals from GPS satellites orbiting the Earth. The GPS unit analyzes the signals to make a transit time and distance estimation. The GPS unit can determine the current position (current location) of the mobile device. Based on these estimations, the mobile device can determine a location fix, altitude, and/or current speed. A location fix can be geographical coordinates such as latitudinal and longitudinal information. In other examples, device 900 may be configured to identify GLONASS signals, or any other similar type of satellite navigational signal.

One or more processors 918 run various software components stored in medium 902 to perform various functions for device 900. In some examples, the software components include an operating system 922, a communication module (or set of instructions) 924, a location module (or set of instructions) 926, an image processing module 928, an odometry module 930, other applications (or set of instructions) 934, such as a car locator app and a navigation app, and a fitment issue module 936 configured to perform operations described herein relating to detecting a fitment issue.

Operating system 922 can be any suitable operating system, including iOS, Mac OS, Darwin, RTXC, LINUX, UNIX, OS X, WINDOWS, or an embedded operating system such as VxWorks. The operating system can include various procedures, sets of instructions, software components and/or drivers for controlling and managing general system tasks (e.g., memory management, storage device control, power management, etc.) and facilitates communication between various hardware and software components.

Communication module 924 facilitates communication with other devices over one or more external ports 936 or via wireless circuitry 908 and includes various software components for handling data received from wireless circuitry 908 and/or external port 936. External port 936 (e.g., USB, FireWire, Lightning connector, 60-pin connector, etc.) is adapted for coupling directly to other devices or indirectly over a network (e.g., the Internet, wireless LAN, etc.).

Location/motion module 926 can assist in determining the current position (e.g., coordinates or other geographic location identifier) and motion of device 900. Modern positioning systems include satellite based positioning systems, such as Global Positioning System (GPS), cellular network positioning based on “cell IDs,” and Wi-Fi positioning technology based on a Wi-Fi networks. GPS also relies on the visibility of multiple satellites to determine a position estimate, which may not be visible (or have weak signals) indoors or in “urban canyons.” In some examples, location/motion module 926 receives data from GPS unit 948 and analyzes the signals to determine the current position of the mobile device. In some examples, location/motion module 926 can determine a current location using Wi-Fi or cellular location technology. For example, the location of the mobile device can be estimated using knowledge of nearby cell sites and/or Wi-Fi access points with knowledge also of their locations. Information identifying the Wi-Fi or cellular transmitter is received at wireless circuitry 908 and is passed to location/motion module 926. In some examples, the location module receives the one or more transmitter IDs. In some examples, a sequence of transmitter IDs can be compared with a reference database (e.g., Cell ID database, Wi-Fi reference database) that maps or correlates the transmitter IDs to position coordinates of corresponding transmitters, and computes estimated position coordinates for device 900 based on the position coordinates of the corresponding transmitters. Regardless of the specific location technology used, location/motion module 926 receives information from which a location fix can be derived, interprets that information, and returns location information, such as geographic coordinates, latitude/longitude, or other location fix data.

Image processing module 928 can include various sub-modules or systems, e.g., as described herein with respect to FIGS. 2-8 .

Odometry module 930 can perform odometry techniques to determine the location and orientation of an electronic device within a physical environment. Output from the camera 944 and the sensors 946 can be accessed by the odometry module 930, and the odometry module 930 can use this information to perform visual inertial odometry techniques. The odometry module 930 can identify and compare features in sequential images captured by camera 944 to determine the camera's movement relative to those features. The odometry module 930 may use information from the sequential images to create a map of the environment. In addition, or alternatively, inertial information from sensors 946 can be used to estimate the movement of the electronic device. Inertial information can include any combination of linear acceleration, angular acceleration, linear velocity, angular velocity, and magnetometer readings, and the inertial information can be in any number of axes.

The one or more application programs 934 on the mobile device can include any applications installed on the device 900, including without limitation, a browser, address book, contact list, email, instant messaging, word processing, keyboard emulation, widgets, JAVA-enabled applications, encryption, digital rights management, voice recognition, voice replication, a music player (which plays back recorded music stored in one or more files, such as MP3 or AAC files), etc.

There may be other modules or sets of instructions (not shown), such as a graphics module, a time module, etc. For example, the graphics module can include various conventional software components for rendering, animating, and displaying graphical objects (including without limitation text, web pages, icons, digital images, animations, and the like) on a display surface. In another example, a timer module can be a software timer. The timer module can also be implemented in hardware. The time module can maintain various timers for any number of events.

The I/O subsystem 906 can be coupled to a display system (not shown), which can be a touch-sensitive display. The display system displays visual output to the user in a GUI. The visual output can include text, graphics, video, and any combination thereof. Some or all of the visual output can correspond to user-interface objects. A display can use LED (light emitting diode), LCD (liquid crystal display) technology, or LPD (light emitting polymer display) technology, although other display technologies can be used in other examples.

In some examples, I/O subsystem 906 can include a display and user input devices such as a keyboard, mouse, and/or track pad. In some examples, I/O subsystem 906 can include a touch-sensitive display. A touch-sensitive display can also accept input from the user based on haptic and/or tactile contact. In some examples, a touch-sensitive display forms a touch-sensitive surface that accepts user input. The touch-sensitive display/surface (along with any associated modules and/or sets of instructions in medium 902) detects contact (and any movement or release of the contact) on the touch-sensitive display and converts the detected contact into interaction with user-interface objects, such as one or more soft keys, that are displayed on the touch screen when the contact occurs. In some examples, a point of contact between the touch-sensitive display and the user corresponds to one or more digits of the user. The user can make contact with the touch-sensitive display using any suitable object or appendage, such as a stylus, pen, finger, and so forth. A touch-sensitive display surface can detect contact and any movement or release thereof using any suitable touch sensitivity technologies, including capacitive, resistive, infrared, and surface acoustic wave technologies, as well as other proximity sensor arrays or other elements for determining one or more points of contact with the touch-sensitive display.

Further, the I/O subsystem can be coupled to one or more other physical control devices (not shown), such as pushbuttons, keys, switches, rocker buttons, dials, slider switches, sticks, LEDs, etc., for controlling or performing various functions, such as power control, speaker volume control, ring tone loudness, keyboard input, scrolling, hold, menu, screen lock, clearing and ending communications and the like. In some examples, in addition to the touch screen, device 900 can include a touchpad (not shown) for activating or deactivating particular functions. In some examples, the touchpad is a touch-sensitive area of the device that, unlike the touch screen, does not display visual output. The touchpad can be a touch-sensitive surface that is separate from the touch-sensitive display, or an extension of the touch-sensitive surface formed by the touch-sensitive display.

In some examples, some or all of the operations described herein can be performed using an application executing on the user's device. Circuits, logic modules, processors, and/or other components may be configured to perform various operations described herein. Those skilled in the art will appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium, such as a compact disk (CD) or DVD (digital versatile disk), flash memory, and the like. The computer readable medium may be any combination of such storage or transmission devices.

Computer programs incorporating various features of the present disclosure may be encoded on various computer readable storage media; suitable media include magnetic disk or tape, optical storage media, such as compact disk (CD) or DVD (digital versatile disk), flash memory, and the like. Computer readable storage media encoded with the program code may be packaged with a compatible device or provided separately from other devices. In addition, program code may be encoded and transmitted via wired optical, and/or wireless networks conforming to a variety of protocols, including the Internet, thereby allowing distribution, e.g., via Internet download. Any such computer readable medium may reside on or within a single computer product (e.g., a solid state drive, a hard drive, a CD, or an entire computer system), and may be present on or within different computer products within a system or network. A computer system may include a monitor, printer, or other suitable display for providing any of the results mentioned herein to a user.

As described above, one aspect of the present technology is the gathering and use of data available from various sources to improve prediction of users that a user may be interested in communicating with. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to predict users that a user may want to communicate with at a certain time and place. Accordingly, use of such personal information data included in contextual information enables people centric prediction of people a user may want to interact with at a certain time and place. Further, other uses for personal information data that benefit the user are also contemplated by the present disclosure. For instance, health and fitness data may be used to provide insights into a user's general wellness or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates examples in which users selectively block the use of, or access to, personal information data. That is, the present disclosure contemplates that hardware and/or software elements can be provided to prevent or block access to such personal information data. For example, in the case of people centric prediction services, the present technology can be configured to allow users to select to “opt in” or “opt out” of participation in the collection of personal information data during registration for services or anytime thereafter. In another example, users can select not to provide location information for recipient suggestion services. In yet another example, users can select to not provide precise location information but permit the transfer of location zone information. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed examples, the present disclosure also contemplates that the various examples can also be implemented without the need for accessing such personal information data. That is, the various examples of the present technology are not rendered inoperable due to the lack of all or a portion of such personal information data. For example, users that a user may want to communicate with at a certain time and place may be predicted based on non-personal information data or a bare minimum amount of personal information, such as the content being requested by the device associated with a user, other non-personal information, or publicly available information.

Although the disclosure has been described with respect to specific examples, it will be appreciated that the disclosure is intended to cover all modifications and equivalents within the scope of the following claims.

All patents, patent applications, publications, and descriptions mentioned herein are incorporated by reference in their entirety for all purposes. None is admitted to be prior art. Where a conflict exists between the instant application and a reference provided herein, the instant application shall dominate.

What is claimed is:

1. A method performed by a headset device, comprising:
detecting, via one or more sensors of the headset device, an indication that a user has placed the headset device on a head of the user;
performing, using at least one of the one or more sensors of the headset device, one or more measurements for contact between the head of the user and the headset device;
determining one or more contact measures between the head of the user and the headset device using the one or more measurements;
comparing the one or more contact measures to one or more predetermined device fit parameters;
determining the one or more contact measures do not satisfy the one or more predetermined device fit parameters; and
responsive to the determination, providing, to the user, a notification indicating a quality of fit for the user.

2. The method of claim 1, wherein the one or more sensors comprises one or more sound sensors that recognizes the user is present.

3. The method of claim 1, wherein the one or more sensors comprise at least one of one or more pressure sensors, one or more sound sensors, or one or more light sensors.

4. The method of claim 1, further comprising capturing, using one or more cameras of the headset device, images associated with the headset device.

5. The method of claim 4, wherein the one or more measurements comprise determining, via the images, positions of eyes of the user and distance between eyes of the user and lenses of the headset device.

6. The method of claim 1, wherein determining the one or more contact measures between the head of the user and the headset device using the one or more measurements comprises determining a pressure measurement at different locations of the headset device.

7. The method of claim 1, further comprising detecting, via the one or more sensors of the headset device, a user adjustment event that indicates the user has made an adjustment to the headset device.

8. The method of claim 7, wherein detecting the user adjustment event comprises using one or more machine learning models.

9. The method of claim 7, wherein providing, to the user, the notification indicating a quality of fit for the user is based, at least in part, on the user adjustment event.

10. The method of claim 1, wherein determining the one or more contact measures do not satisfy the one or more predetermined device fit parameters comprises using one or more machine learning models.

11. A headset device, comprising:
one or more processors;
one or more sensors; and
a memory coupled to the one or more processors, the memory storing instructions that cause the one or more processors to perform operations including:
detecting, via the one or more sensors, an indication that a user has placed the headset device on a head of the user;
performing, using at least one of the one or more sensors, one or more measurements for contact between the head of the user and the headset device;
determining one or more contact measures between the head of the user and the headset device using the one or more measurements;
comparing the one or more contact measures to one or more predetermined device fit parameters;
determining the one or more contact measures do not satisfy the one or more predetermined device fit parameters; and
responsive to the determination, providing, to the user, a notification indicating a quality of fit for the user.

12. A method comprising:
detecting, via one or more sensors of a headset device, an indication that a user has placed the headset device on a head of the user;
performing, by at least one of the one or more sensors, a series of measurements;
detecting an adjustment event made by the user to the headset device based on the series of measurements;
determining that a number of adjustment events exceeds a threshold; and
providing, to the user, a notification indicating a quality of fit for the user.

13. The method of claim 12, wherein detecting the adjustment event comprises:
performing additional measurements using the one or more sensors;
detecting additional adjustment events using the additional measurements;
incrementing an adjustment counter based on detecting the additional adjustment events; and
comparing the adjustment counter to a threshold.

14. The method of claim 13, wherein the additional measurements comprise sound of the user touching the headset device.

15. The method of claim 14, wherein the additional measurements comprise light information that indicates an amount of light entering the headset device.

16. The method of claim 12, wherein the one or more sensors comprise one or more of: image sensors, motion sensors, touch sensors, and microphones.

17. The method of claim 12, wherein the series of measurements comprises motion information or touch information for the headset device.

18. The method of claim 12, further comprising capturing, using one or more cameras, images of the headset device detecting a hand of the user touching the headset device.

19. The method of claim 12, wherein detecting the adjustment event comprises using one or more machine learning models.

20. The method of claim 12, further comprising detecting a fitment issue using one or more machine learning models.
